(19) United States
(12) Patent Application Publication
(10) Pub. No.: US 2018/0246774 A1
(43) Pub. Date: Aug. 30, 2018

(54) Intelligent Networked Architecture for Real-Time Remote Events Using Machine Learning

(71) Applicant: NURV Ltd., Thornton, CO (US)

(72) Inventor: Jason Byrne, Cherry Hills Village, CO (US)

(21) Appl. No.: 15/908,629

(22) Filed: Feb. 28, 2018

Related U.S. Application Data
(60) Provisional application No. 62/465,077, filed on Feb. 28, 2017.

(51) Int. Cl. G06F 9/54; G06F 17/30; G06N 99/00

(52) U.S. Cl. CPC G06F 9/542; G06N 99/005; G06F 17/30867

(57) ABSTRACT

Intelligent networked architecture for real-time remote events using machine learning are provided herein. An example system includes a client device executing a real-time event application, the client device being associated with a first entity, a second client device being associated with a second entity, a management server configured to: receive second entity data, third entity data, and event data regarding an event, build a plurality of second entity profiles based on the second entity data, select the second entity from the plurality of second entity profiles, based on a match between the second entity profile of the second entity and the event data based on demand scores; and transmit a notification to the second entity in real-time that the entity has been selected, the notification including at least the event data.

### CROSS REFERENCE TO RELATED APPLICATIONS

This application claims the benefit and priority of U.S. Provisional Application Ser. No. 62/465,077, filed on Feb. 28, 2017, which is hereby incorporated by reference herein in its entirety, including all references and appendices cited therein.

### FIELD OF THE TECHNOLOGY

Embodiments of the disclosure relate to an intelligent networked architecture that provides event-drive machine learning that leverage feedback in order to facilitate the real-time events.

### SUMMARY

Various embodiments of the present disclosure are directed to a system that includes a client device executing a real-time event application, the client device being associated with a first entity, a second client device being associated with a second entity, a management server configured to: receive second entity data, third entity data, and event data regarding an event, build a plurality of second entity profiles based on the second entity data, select the second entity from the plurality of second entity profiles, based on a match between the second entity profile of the second entity and the event data based on demand scores; and transmit a notification to the second entity in real-time that the entity has been selected, the notification including at least the event data.

Various embodiments of the present disclosure are directed to a receiving second entity data, third entity data, and event data regarding an event, building a plurality of second entity profiles based on the second entity data, selecting the second entity from the plurality of second entity profiles, based on a match between the second entity profile of the second entity and the event data based on demand scores; and transmitting a notification to a second client device of the second entity in real-time that the entity has been selected, the notification comprising the event data.

Various embodiments of the present disclosure are directed to a system comprising: a management server configured to communicate with a client device executing a real-time event application, the client device being associated with a first entity and a second client device being associated with a second entity, the management server being further configured to: receive second entity data, third entity data, and event data regarding an event; build a plurality of second entity profiles based on the second entity data; select the second entity from the plurality of second entity profiles, based on a match between the second entity profile of the second entity and the event data based on demand scores; and transmit a notification to the second entity in real-time that the entity has been selected, the notification comprising the event data.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a high level schematic diagram of computing architecture for practicing aspects of the present technology.

FIG. 2 is a flowchart of an example real-time, machine learning based event methods disclosed herein.

FIG. 3 is a flowchart of additional aspect of the real-time, machine learning based event methods disclosed herein.

FIG. 4 is a diagrammatic representation of an example machine in the form of a computer system.

### DETAILED DESCRIPTION OF EXEMPLARY EMBODIMENTS

Generally speaking, the present disclosure is related to intelligent network architectures that utilize machine learning in order to facilitate events that occur in real time. As the parameters of the event change, the machine learning aspects of the intelligent network architecture can reconfigure parameters of the event in real time, providing participants in the event with real time feedback and alerts.

In general, the systems and methods disclosed herein can utilize both user provided information from two parties to a negotiation, such as a buyer and a seller. Each of these parties can provide information regarding their preferences for the particular types of deals for which they have an interest. For example, a home seller and a home buyer can include their respective known preferences. While the seller's information is usually limited to the attributes about the property they have for sale, buyer attributes are usually less specific and more conceptual. In one example, a buyer may specific ranges of acceptable parameters for properties they are interested in purchasing. In some embodiments, in addition to the subjective information provided by each of the participants, the systems and method herein can utilize aggregated data from similar sellers, buyers, and purchases in order to make calculated probabilistic assumptions about how probable it is for any given buyer in the system to place an offer on a property for sale, as well as finally consummate the sale by closing.

In some embodiments, the systems and methods herein can also make probabilistic calculations about current demand for property with respect to buyers in the system by tracking the behaviors of the buyers over time. For example, as potential properties are presented to a buyer, the respective responses from the buyer are tracked and used to update the profile of the buyer in the system. Thus, the machine learning aspects of the systems and methods herein allow for feedback-based learning of buyer preferences over time, not only from an aggregate of other similarly situated buyers in similar purchase scenarios, but also from specific feedback received when the buyer is presented with a particular property. These feedback loops advantageously uncover hidden preferences that the buyer may not be aware of initially.

Advantageously, these features can be used cooperatively to allow a third party or middleman purchaser to negotiate with a seller, knowing one or more qualified buyers are willing to purchase the property at a higher retail price. In general, a third party can include any intermediary party (or agent or functionary of a third party) that is positioned between the buyer and a seller in a transaction or event. Third parties could include an employee or independent contractor of a wholesaler, or even an end party who paid a subscription fee for access to the system, or a “real estate brokerage that has no real estate agents” which could include a company that provides services to a captive network of non-realtor users (e.g., agents or owner occupant buyers wanting to buy direct with no agents) who use our platform.

In an example use case, the third party purchases a property at a sub-wholesale price and sells the same at wholesale to a buyer. However this model works well buying at wholesale and selling at retail, or even buying at high wholesale and selling at low retail. In the latter example a mobile application is implemented for retail buyers wanting a “deal” on a sub retail house—no agents involved. Some embodiments can allow for linking sellers and buyers via any methodology discussed in this disclosure.

The third party can act on their own behalf or on the behalf of the buyer and/or or the seller. The third party can be a first purchaser that buys a property from the seller and then resells the property to a buyer.

In more detail, the machine learning system can first match a property to one or more buyers based on a demand score calculated for the property. Again, the price offered to the set of buyers is related to a calculated retail price of the property that takes into consideration the attributes of the property that are relevant to sales price which are known to one of ordinary skill in the art.

This process effectively filters a set of buyers from the larger population of all potential buyers. Next, the third party can utilize real-time gathered information on premises that is transmitted to the system in order to further refine the set of buyers. When this refined set of buyers is identified, the system will automatically transmit alerts to these buyers that the property is being offered in real-time. As the process unfolds the behaviors of the parties are tracked and recorded.

The third party uses the demand score and the calculated retail price in order to formulate a second lower price, referred to as a wholesale price, which is a price (or another similar offer) offered to the seller if one or more willing buyers are identified. In some instances, thresholding is used to determine if a wholesale price is even achievable. For example, if the demand score indicates that the buyer is likely to purchase the property for 80% of the retail value, the third party is likely to engage with the seller. Thus, ranges of demand scores indicating 90-100% (just as an example) of retail value from a buyer would be indicative of a property not suitable for purchasing by the third party. On the other hand, if the demand score indicates that the buyer is willing to purchase for less than 90% of the retail value of the property, the buyer will likely be selected by the system for consideration.

In some instances, a wholesale value is calculated that represents an offer to the seller from the third party that is a percentage of the demand score. For example if the demand score is 85%, the third party may make an offer that is commensurate with the demand score. In some embodiments, machine gathered knowledge of buyer preferences allow the third party to leverage offers despite not having a demand score that is acceptable. The third party can recalibrate the expectations of the seller based on machine gathered knowledge of buyer preferences (e.g., knowing what they will pay in view of a multivariate assessment of their preferences). These and other objects of the present disclosure are provided in greater detail herein.

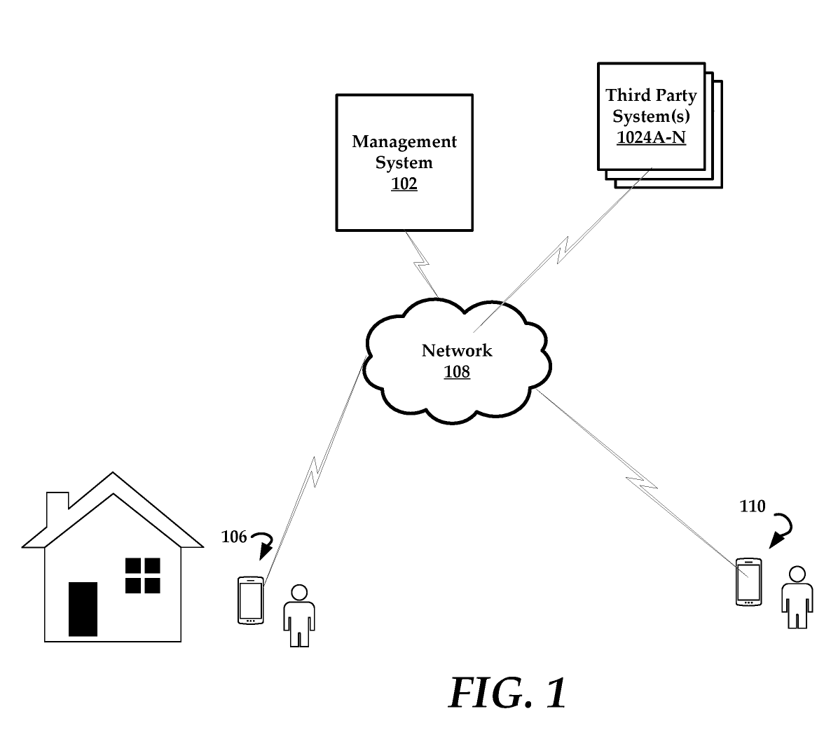

FIG. 1 is an example architecture of a system and environment where aspects of the present disclosure are practiced. In general, the system includes a server-side portion of the system comprising a management server 102 and one or more third party services 104A-N that provide historical transactional data. The server-side portion of the system facilitates real-time transaction processes such as first-look auctions, as well as user alerts and so forth, as will be discussed in greater detail infra.

End users such as third partys can utilize features of the server-side portion of the system in real-time negotiations with property sellers on premises using a client device 106 such as a Smartphone or laptop. The client device 106 can utilize an application to communicate with the server-side portion of the system or the server-side portion of the system can provide a web interface that the client device 106 can utilize. An advantage of a web interface provided by the server-side portion of the system is that such web interfaces can be implemented to be device agnostic allowing a wider range of devices to use the server-side portion of the system.

In one or more embodiments, the client device 106 is coupled with the management server 102 through a network 108. The network 108 can include any public and/or private network. Also, the server-side portion of the system can also communicate in real-time with a buyer client device 110 over the network 108.

As mentioned above, both buyers and sellers, using their respective devices, can provide buyer specific information and seller specific information, respectively. For example, a prospective buyer can include information such as parameters of properties they are interested in purchasing, including specific property features. Also, the system can collect information regarding the buyers financial position, such as cash on hand. To be sure, in some instances, the systems disclosed herein facilitate private sales of property without, which does not require using a typical multi-listing system (MLS).

In some embodiments, there can be thousands or more buyers and sellers listed in the management server 102. Each individual will have a unique profile that is specifically tailored to their needs as a buyer and/or a seller. Also, the parties to a property transaction can often provide information that they believe is relevant but in reality is not relevant to consummating a transaction. The systems and methods herein can parse data obtained from a variety of sources (including buyers and sellers) for data that is highly relevant to a particular transaction. That is, the selected data is driven by the unique position of the seller, the buyer, and the underlying property.

As noted above, the management server 102 can utilize not only the information gathered directly from the buyers or sellers, but also from the third party services 104A-N. The third party services 104A-N can provide, for example, historical information about off-market, on-market, or private property sales conducted by investors (e.g., investing buyers). Also, the management server 102 generates and continually updates a datastore with empirical information about purchases transacted between buyers and sellers through the management server 102. This includes both failed matches and successful transactions. This empirical data can also be obtained by randomly or periodically providing buyers with available property profiles and having the buyers grade the property in terms of buyer interest. This information can be used by the management server 102 to iteratively update the buyer's profile.

The management server 102 implements machine learning in order to process these multi-variate data sets. That is, a volume of transaction information gathered by both the management server 102 and obtained by the third party services 104A-N, while robust, requires machine intervention in order to properly calculate real-time demand scores, automatically generated alerts to buyers, and facilitate real-time sales and auctions (e.g., first-look) with sellers. While traditional real estate purchases can take on the order of days or weeks, using the systems and methods herein buyers and sellers reduce these times to an hour or less.

It will be understood that the use of buyer demand scores and profiling allows the system to intelligently identify, for example a large set of buyers who want a house just like a particular target property that is owned by a unique seller. The systems disclosed herein can target marketing to owners of these houses with a call to action, as well as specific marketing into those specific neighborhoods to see who wants to sell.

It will be understood that a high buyer demand score indicates buyers paying more for properties and therefore the system that suggest that sellers be paid more and maintain margins. Buyers paying more is integral, as the more buyers will pay the more the third party will pay and the more supply is available.

As mentioned herein, the management server 102 will effectively, and in real-time, match sellers and their properties with buyers. In some embodiments, the management server 102 will ingest information regarding a plurality of sellers and their associated properties for sale. The management server 102 will then calculate a demand score for each property relative to each buyer profile. When the demand score is within an acceptable range of demand scores, the management server 102 can push an alert to the buyer in real-time. Advantageously, it is the nature of real-estate transactions that buyers are continually looking for opportunities and will act quickly when a reasonable deal is presented. Any delay in presenting a matching deal to a buyer can result in a sale loss, especially in property markets where inventory is sparse or where investors are purchasing properties rapidly to keep pace with market conditions. Thus, conducting transactions in real-time using machine learning to automatically filter buyers, along with real-time alerting can overcome these issues related to latency that occurs in human driven processes.

In general, a demand score is indicative of a price a selected buyer (filtered by multivariate analysis) will likely pay (e.g., probability) for a property as a retail value. For example, the management server 102 may determine that out of 1,000 potential buyers that only six buyers correspond to the unique multivariate matching between a particular seller, a particular property, and these buyers. A demand score can be calculated for each of the buyers or sellers. The demand score can be calculated from the point of view of the seller or the point of view of the buyer. From the point of view of the seller, the demand score is indicative of how far off the retail price the seller is willing to move in order to facilitate a sale. Many other factors other than price can be a factor such as timeline to move seller needs, leaving unwanted items in house, having bad tenants, evicting tenants, staying after close, helping sellers find their next house to buy or rent, helping with moving costs, how much fix there is (determines what kind of investor can buy—what threshold investor has for construction and uncertainty, and so forth—just to name a few.

From the point of view of the buyer, the demand score is indicative of how close to the retail price the buyer is likely to offer in order to facilitate a sale. In some embodiments, if the seller's price is known and this price is acceptable to a third party, the management server 102 can search for a match with buyers who are have a demand score that indicates that they would be amicable to buying the property at the price established by the management server 102. To be sure, the price that is acceptable to the third party is a price that allows the third party to buy the property at wholesale, knowing that one or more willing buyers will pay a higher price than what was paid by the third party, which includes the margin that the third party is willing to accept. Thus, the “list” price to the third party is lower than the list price that will be paid by the ultimate end purchaser, but the management server 102 will calculate what the best price is for the third party based on what it expects the end purchaser to offer (based on knowledge of the property and the market).

If a buyer is willing to pay 90% of sales price, the management server 102 can inform the third party that they should offer only 80% of the estimated retail sales price of the property in order to make a deal (assuming the wholesaler is known to prefer deals where their margin is at least 10% of the purchase price). Each party can specify the guidelines (e.g., preferred margins) of how sensitive the management server 102 should be with respect to how much of a spread should be present in order to make the transaction appealing.

The systems and methods herein can be adapted to allow for direct seller to buyer transactions, rather than also accounting for the preferences of third partys.

In some embodiments, when real-time notifications are sent to this selected set of buyers, the management server 102 will collect and utilize any feedback from the buyers such as requests to view the property, submissions of offers (and their value) or counter offers, closings, buyer behaviors, and so forth. Again, these types of data collected over time are used to refine the buyer and seller profiles. This information can also be used in the aggregate to predict behaviors of other similar sellers and/or buyers.

In an example use case, a seller desires to sell property. The seller will enter both seller information and property information into the management server 102. The management server 102 can also use third party services 104A-N to collect information on the seller and/or the property to automatically reduce the amount of information required from the seller, as well as increase accuracy, immediacy, and intelligence of the demand scores in general. This information can be manually entered or can be obtained from a third party service, such as a county assessor website that includes objective property information.

Once entered, the management server 102 begins a multivariate analysis of the seller and property information, matching the same with potential buyer profiles on the management server 102. Again, this matching process can utilize third party resources such as historical purchase information to determine which buyers are most suitable for the seller and property using multi-variate analysis.

In some embodiments, a third party can be present at the property and may have access to the seller. In these on premises embodiments, the wholesaler can continually update the property information in real-time as the wholesaler examines and inspects the property for issues or features (such as, but not limited to condition of the property, structural issues, fix up estimates, takes real time video using Facebook live (one to many, like a video conference with many buyers involved, as well as many other things buyers want to see in real time in order to learn more and refine their fix estimates and after repair value) the seller may not have put into the property profile. Rather than relying on subjective seller provided data, the wholesaler can objectively review the property and update the property profile through use of their client device 106. As the property profile changes, real-time updates occur in the management server 102, causing a dynamic and automatic recalculation of demand scores. This recalculation of demand scores can cause the selection of buyers to change. For example, if the seller did not indicate that the property was on a busy street, and one or more previously selected buyers indicated that they would never buy a property on a busy street, the management server 102 can automatically remove these buyers and transmit a notice to them in real-time that they have been removed and reasons for the removal.

Conversely, this may trigger notification of other buyers depending on how the parameters of the property change. Also, the real-time updating allows buyers to place real-time bids and also to provide buyers with the opportunity to ask for specific information about the property such as exact square footage, aesthetic condition (e.g., paint, carpet, tile, etc.), and to obtain information such as photographs and videos in real time. This can be facilitated by direct communication between the third party and the buyer through their respective devices, or as mediated through the management server 102.

In one example case, a wholesaler can attempt to calculate estimated repair costs based on a buyer list that indicates the typical repairs the buyer makes to similar properties (e.g., fix values). This information allows the buyer to calculate an after repair value (ARV) for the property and potentially exclude properties for which fix values cannot be determined or would be unfeasible.

Each unique ask for information from a buyer regarding the property is a new facet of information that can be used to fine-tune the buyer profile.

In some instances, based on empirical feedback, the seller may decide to drop their price if no offer is presented in real-time. In some embodiments, the buyers can present a counter offer. Again, these offers and counter offers are mediated through the management server 102 with the wholesaler as part of the calculation. Thus, a converging solution is created that allows each party: seller, buyer, and wholesaler to receive their desired compensation. It will be understood that a wholesaler aids the immediacy of price discovery and acts as force for a deal moving forward quickly and forcefully. The wholesaler can also create liquidity for the seller immediately by purchasing the property immediately in order to be a financial intermediary, as well as a deal conduit, with buyer and seller.

In some embodiments, the management server 102 calculates this converging solution and presents each party with the respective “best” property price for all three. In this way, transactions are conducted in a fair and equitable manner.

In some embodiments, the management server 102 can use knowledge of successful transactions and their respective demand scores to automatically calculate demand scores for other similar properties for sale in a same geographical area. These sales are highly likely to result in a successful sale. The system can use this intelligence to provide pinpoint marketing to get more houses requested by higher demand scores from buyers.

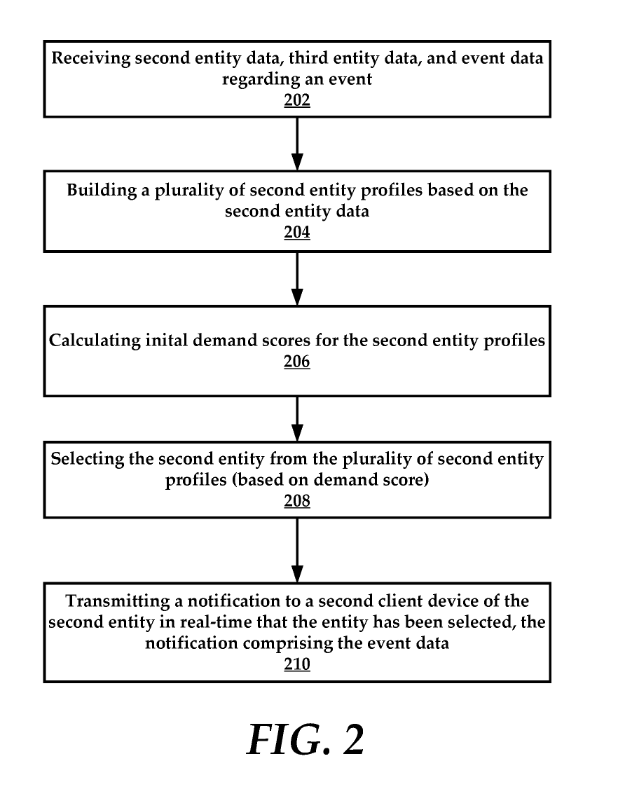

FIG. 2 is a flowchart of an example method of real-time event management using the systems disclosed herein. In some embodiments, the method includes a step 202 of receiving second entity data, third entity data, and event data regarding an event. In general, the second entity data includes data received from a second entity or buyer, whereas the third entity is a seller and the event involves the sale of property owned by the seller. A first entity in this instance would include a wholesale buyer who is directly working with the third entity and/or buyer.

In some embodiments, the second and third entities each create their respective profiles stored on a management system. This includes information solicited on forms provided by the management system.

In some embodiments, the method includes a step 204 of building a plurality of second entity profiles based on the second entity data. That is each buyer creates their own profile on the management system that includes the types of properties that the buyer is interested in, as well as other information that determines the suitability of the buyer to engage in a property transaction. In some embodiments, historical information and financing history can affect how the system views the buyer as suitable.

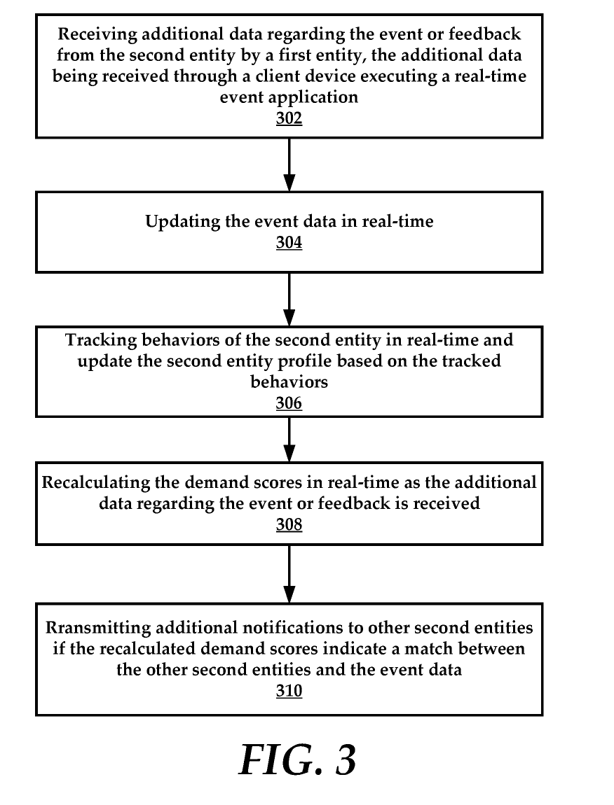

Once these entity defined profiles have been created, the method includes the management system performing a step 206 of calculating initial demand scores. These scores can be enhanced through using aggregated historical data, as well as entity data that is gathered over time based on behaviors of the entities. For example, responses of buyers when receiving sale prices for properties can be used to enhance the buyer profiles. These machine learning aspects of the management system are disclosed and illustrated in greater detail with reference to FIG. 3.

In some embodiments, the method includes a step 208 selecting the second entity from the plurality of second entity profiles. This selection is based on a match between the second entity profile (e.g., buyer profile) of the second entity and the event data based on demand scores. To be sure, multiple buyer profiles may match in some instances.

In various embodiments, the method includes a step 210 of transmitting a notification to a second client device of the second entity in real-time that the entity has been selected, the notification comprising the event data. This informs the buyer that a deal is available.

Turning now to FIG. 3, machine learning and real-time updating aspects of the management system are illustrated in this flowchart. This method can initiate after step 210 of FIG. 2, in some instances. In some embodiments, the method includes a step 302 of receiving additional data regarding the event or feedback from the second entity by a first entity, the additional data being received through a client device executing a real-time event application. For example, if the first party (e.g., wholesale buyer) is present at the property, the first party can obtain more refined or corrected information about the property. This can include instances where additional information is gathered based on buyer requests for more specific information. Again, these processes are proceeding in real time. Thus, the method includes a step 304 of updating the event data in real-time.

The method also includes a step 306 of tracking behaviors of the second entity in real-time and update the second entity profile based on the tracked behaviors. For example, if the buyer is presented with the offer, but requests additional information, these parameters can be added to the buyer profile such that future offers would include these parameters if the buyer is to be a party to a deal.

Once changes to the event data and/or buyer behaviors (e.g., buyer feedback) are determined, the method includes the management system performing a step 308 of recalculating the demand scores in real-time as the additional data regarding the event or feedback is received.

In one or more embodiments, the method includes a step 310 of transmitting additional notifications to other second entities (new buyers that match based on the recalculated demand scores) if the recalculated demand scores indicate a match between the other second entities and the event data. This process can also alternatively cause a buyer who was originally selected to be removed from consideration.

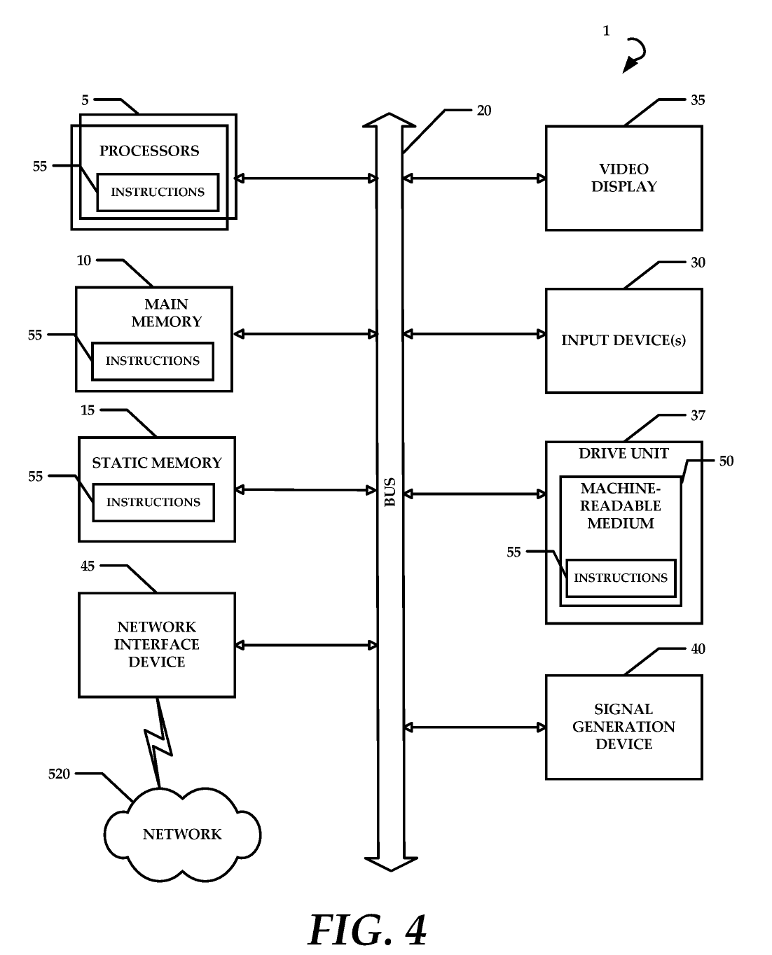

FIG. 4 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include input device(s) 30 (also referred to as alpha-numeric input device(s), e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a machine-readable medium 50 (which may be a computer readable medium) on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network (e.g., network 150 or network 520, see FIG. 1 and FIG. 5, respectively) via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary

What is claimed is:

1. A system, comprising:
a client device executing a real-time event application, the client device being associated with a first entity;
a second client device being associated with a second entity;
a management server configured to:
receive second entity data, third entity data, and event data regarding an event;
build a plurality of second entity profiles based on the second entity data;
select the second entity from the plurality of second entity profiles, based on a match between the second entity profile of the second entity and the event data based on demand scores; and
transmit a notification to the second entity in real-time that the entity has been selected, the notification comprising the event data.

2. The system according to claim 1, wherein the management server is further configured to receive additional data regarding the event or feedback from the second entity, via the client device of the first entity who is interacting with the third entity in real-time.

3. The system according to claim 2, wherein the management server is further configured to update the event data in real-time.

4. The system according to claim 3, wherein the management server is further configured to recalculate the demand scores in real-time.

5. The system according to claim 4, wherein the management server is further configured to transmit additional notifications to other second entities if the recalculated demand scores indicate a match between the other second entities and the event data.

6. The system according to claim 5, wherein the management server is further configured to obtain third-party event data and update the second entity data, the third entity data, and the event data based on the third-party event data, the third-party event data comprising historical aggregated event data.

7. The system according to claim 6, wherein the management server is further configured to track behaviors of the second entity in real-time and update the second entity profile based on the tracked behaviors.

8. The system according to claim 7, wherein the second entity is removed from consideration based on the update of the second entity profile.

9. The system according to claim 1, wherein the demand score is indicative of a probability that the second entity will perform a transaction based on the event.

10. The system according to claim 9, wherein the event comprises a property sale.

11. A method, comprising:
receiving second entity data, third entity data, and event data regarding an event;
building a plurality of second entity profiles based on the second entity data;
selecting the second entity from the plurality of second entity profiles, based on a match between the second entity profile of the second entity and the event data based on demand scores; and
transmitting a notification to a second client device of the second entity in real-time that the entity has been selected, the notification comprising the event data.

12. The method according to claim 11, further comprising receiving additional data regarding the event or feedback from the second entity by a first entity, the additional data being received through a client device executing a real-time event application.

13. The method according to claim 12, further comprising updating the event data in real-time.

14. The method according to claim 13, further comprising recalculating the demand scores in real-time as the additional data regarding the event or feedback is received.

15. The method according to claim 14, further comprising transmitting additional notifications to other second entities if the recalculated demand scores indicate a match between the other second entities and the event data.

16. The method according to claim 15, further comprising obtaining third-party event data and update the second entity data, the third entity data, and the event data based on the third party event data, the third-party event data comprising historical aggregated event data.

17. The method according to claim 16, further comprising tracking behaviors of the second entity in real-time and update the second entity profile based on the tracked behaviors.

18. The method according to claim 17, wherein the second entity is removed from consideration based on the update of the second entity profile.

19. The method according to claim 11, wherein the demand score is indicative of a probability that the second entity will perform a transaction based on the event.

20. A system, comprising:
a management server configured to communicate with a client device executing a real-time event application, the client device being associated with a first entity and a second client device being associated with a second entity, the management server being further configured to:
receive second entity data, third entity data, and event data regarding an event;
build a plurality of second entity profiles based on the second entity data;
select the second entity from the plurality of second entity profiles, based on a match between the second entity profile of the second entity and the event data based on demand scores; and
transmit a notification to the second entity in real-time that the entity has been selected, the notification comprising the event data.
